(19) United States
(12) Patent Application Publication
(10) Pub. No.: US 2025/0323536 A1
(43) Pub. Date: Oct. 16, 2025

(54) POWER ACCOUNTING FOR WIRELESS POWER TRANSFER WITH SOFT RESTART

(71) Applicant: Apple Inc., Cupertino, CA (US)

(72) Inventors: Tao Li, San Jose, CA (US); Antoin J Russell, Mountain View, CA (US); Guangqi Zhu, Santa Clara, CA (US); Jukka-pekka J Sjoeroos, Cupertino, CA (US); Stephen C Terry, San Jose, CA (US)

(21) Appl. No.: 19/250,758

(22) Filed: Jun. 26, 2025

Related U.S. Application Data
(63) Continuation-in-part of application No. 18/770,264, filed on Jul. 11, 2024.
(60) Provisional application No. 63/549,736, filed on Feb. 5, 2024.
(60) Provisional application No. 63/802,709, filed on May 9, 2025.
(60) Provisional application No. 63/805,579, filed on May 14, 2025.

(51) Int. Cl. H02J 50/80; H02J 50/12; H02J 50/60; H02J 50/90

(52) U.S. Cl. CPC H02J 50/80; H02J 50/12; H02J 50/60; H02J 50/90

(57) ABSTRACT

Operating a wireless power transmitter (PTx) can include using the PTx control circuitry to: initiate a temporary pause of wireless power transfer (WPT); provide a ping signal to cause a resonant voltage in the PTx coil during the temporary pause; use the resonant voltage to measure or characterize one or more electrical, magnetic, or electromagnetic parameters characterizing a WPT link between the PTx and a wireless power receiver; and thereafter resume WPT by ending the temporary pause, which can include a soft restart of an inverter of the PTx. The ping signal can be provided by circuitry that includes a resonant capacitor and one or more switches operable to selectively provide a resonant current circulation path between the PTx coil and the resonant capacitor during the temporary pause and measurement circuitry that measures a resonant voltage associated with the PTx coil and the resonant capacitor caused by the ping signal.

### CROSS-REFERENCE TO RELATED APPLICATIONS

This application is a continuation-in-part of U.S. patent application Ser. No. 18/770,264, filed Jul. 11, 2024, entitled “Power Accounting for Wireless Power Transfer,” which claims priority to U.S. Provisional Application No. 63/549,736, filed Feb. 5, 2024, entitled “Power Accounting for Wireless Power Transfer,” which is incorporated by reference herein in its entirety. This application also claims priority to U.S. Provisional Patent Application No. 63/802,709, filed May 9, 2025, entitled “Power Accounting for Wireless Power Transfer with Soft Restart,” and U.S. Provisional Patent Application No. 63/805,579, filed May 14, 2025, entitled “Power Accounting for Wireless Power Transfer with Soft Restart,” both of which are incorporated by reference herein in their entirety.

### BACKGROUND

Wireless power transfer is used in electronic devices, such as smart phones, tablet computers, smart watches, wireless earphones, styluses, so forth, to facilitate charging of batteries within the devices. In some applications, higher levels of wireless power transfer may be desired, for example to provide for faster charging. Such higher power transfer levels can benefit from techniques to tune system characteristics and operating parameters to improve operating efficiency, voltage regulation, foreign object detection, and the like.

### SUMMARY

A wireless power transmitter can include a wireless power transfer coil configured to magnetically couple to a corresponding coil of a wireless power receiver to perform wireless power transfer to the wireless power receiver; an inverter that receives a DC input voltage and produces an AC output voltage that is provided to the wireless power transfer coil to perform the wireless power transfer; and control and communication circuitry coupled to the wireless power transfer coil and the inverter. The control and communication circuitry can initiate a temporary pause of the wireless power transfer; provide a ping signal to cause a resonant voltage in the wireless power transfer coil during the temporary pause of wireless power transfer; use the resonant voltage to measure or characterize one or more parameters characterizing a wireless power transfer link between the wireless power transmitter and the wireless power receiver; and thereafter resume wireless power transfer by ending the temporary pause of wireless power transfer, wherein resuming wireless power transfer includes a soft restart of the inverter.

The inverter can be a full bridge inverter, and the soft restart of the inverter can be achieved by varying a phase between switching operations of a first half bridge of the full bridge inverter and a second half bridge of the full bridge inverter. The control and communication circuitry can include a resonant capacitor and one or more switching devices operable to selectively provide a resonant current circulation path between the wireless power transmitter coil and the resonant capacitor during the temporary pause; and measurement circuitry that measures a resonant voltage associated with the wireless power transmitting coil and the resonant capacitor caused by the ping signal. The resonant capacitor and one or more switching devices can include the resonant capacitor and a switching device coupled in series between a junction of the wireless power transfer coil with a tuning capacitance arrangement and ground. The resonant capacitor and one or more switching devices can include the resonant capacitor and a first switching device coupled in series between a junction of a first terminal of the wireless power transfer coil with a tuning capacitance arrangement and ground and a second switching device coupled between a second terminal of the wireless power transfer coil and ground.

The control circuitry can use the resonant voltage to measure or characterize one or more parameters characterizing a wireless power transfer link between the wireless power transmitter and the wireless power receiver by measuring or characterizing one or more electrical, magnetic, or electromagnetic parameters characterizing a wireless power transfer link between the wireless power transmitter and an external object. The one or more electrical, magnetic, or electromagnetic parameters characterizing a wireless power transfer link can be used to detect a wireless power receiver. The one or more electrical, magnetic, or electromagnetic parameters characterizing a wireless power transfer link can be used to detect a foreign object. The resonant voltage associated with the wireless power transmitting coil and the resonant capacitor can be a ringing signal induced by the ping signal.

A wireless power transmitter can include a wireless power transfer coil configured to magnetically couple to a corresponding coil of a wireless power receiver to perform wireless power transfer to the wireless power receiver; an inverter that receives a DC input voltage and produces an AC output voltage that is provided to the wireless power transfer coil to perform the wireless power transfer; and control and communication circuitry coupled to the wireless power transfer coil and the inverter. The control and communication circuitry can initiate a temporary pause of the wireless power transfer; provide a ping signal to cause a resonant voltage in the wireless power transfer coil during the temporary pause of wireless power transfer; use the resonant voltage to measure or characterize one or more parameters characterizing a wireless power transfer link between the wireless power transmitter and the wireless power receiver; and thereafter resume wireless power transfer by ending the temporary pause of wireless power transfer. The control and communication circuitry can include a resonant capacitor and one or more switching devices operable to selectively provide a resonant current circulation path between the wireless power transmitter coil and the resonant capacitor during the temporary pause and measurement circuitry that measures a resonant voltage associated with the wireless power transmitting coil and the resonant capacitor caused by the ping signal.

The inverter can be a full bridge inverter; resuming wireless power transfer includes a soft restart of the inverter; and the soft restart of the inverter can be achieved by varying a phase between switching operations of a first half bridge of the full bridge inverter and a second half bridge of the full bridge inverter. The resonant capacitor and one or more switching devices can include the resonant capacitor and a switching device coupled in series between a junction of the wireless power transfer coil with a tuning capacitance arrangement and ground. The resonant capacitor and one or more switching devices can include the resonant capacitor and a first switching device coupled in series between a junction of a first terminal of the wireless power transfer coil with a tuning capacitance arrangement and ground and a second switching device coupled between a second terminal of the wireless power transfer coil and ground.

The control circuitry can use the resonant voltage to measure or characterize one or more parameters characterizing a wireless power transfer link between the wireless power transmitter and the wireless power receiver by measuring or characterizing one or more electrical, magnetic, or electromagnetic parameters characterizing a wireless power transfer link between the wireless power transmitter and an external object. The one or more electrical, magnetic, or electromagnetic parameters characterizing a wireless power transfer link can be used to detect a wireless power receiver. The one or more electrical, magnetic, or electromagnetic parameters characterizing a wireless power transfer link can be used to detect a foreign object. The resonant voltage associated with the wireless power transmitting coil and the resonant capacitor can be a ringing signal induced by the ping signal.

A method of operating a wireless power transmitter including an inverter that drives a wireless power transfer coil to deliver power to a wireless power receiver can include using the wireless power transmitter control circuitry to: initiate a temporary pause of wireless power transfer; provide a ping signal to cause a resonant voltage in the wireless power transmitter coil during the temporary pause of wireless power transfer; use the resonant voltage to measure or characterize one or more electrical, magnetic, or electromagnetic parameters characterizing a wireless power transfer link between the wireless power transmitter and the wireless power receiver; and thereafter resume wireless power transfer by ending the temporary pause of wireless power transfer. Resuming wireless power transfer can include a soft restart of the inverter. Providing the ping signal can include operating circuitry that includes a resonant capacitor and one or more switching devices operable to selectively provide a resonant current circulation path between the wireless power transmitter coil and the resonant capacitor during the temporary pause; and measurement circuitry that measures a resonant voltage associated with the wireless power transmitting coil and the resonant capacitor caused by the ping signal.

The inverter can be a full bridge inverter. The soft restart of the inverter can include varying a phase between switching operations of a first half bridge of the full bridge inverter and a second half bridge of the full bridge inverter. The resonant capacitor and one or more switching devices can include the resonant capacitor and a switching device coupled in series between a junction of the wireless power transfer coil with a tuning capacitance arrangement and ground. The resonant capacitor and one or more switching devices can include the resonant capacitor and a first switching device coupled in series between a junction of a first terminal of the wireless power transfer coil with a tuning capacitance arrangement and ground and a second switching device coupled between a second terminal of the wireless power transfer coil and ground. The resonant voltage associated with the wireless power transmitting coil and the resonant capacitor is a ringing signal induced by the ping signal.

### BRIEF DESCRIPTION OF THE DRAWINGS

FIG. 1 illustrates a simplified block diagram of a wireless power transfer system.

FIG. 2 illustrates alternative embodiments of a wireless charger device.

FIG. 3 illustrates a simplified schematic of a wireless charger device.

FIG. 4 illustrates a technique for pausing wireless power transfer to perform measurements characterizing the wireless link in a wireless power transfer system.

FIG. 5 illustrates wireless power receiver operation during a pause in wireless power transfer to perform measurements characterizing the wireless link in a wireless power transfer system.

FIG. 6 illustrates a simplified flow chart of wireless power transmitter and wireless power receiver operation during a pause in wireless power transfer to perform measurements characterizing the wireless link in a wireless power transfer system.

FIG. 7 illustrates wireless power receiver operation during a pause in wireless power transfer to perform measurements characterizing the wireless link in a wireless power transfer system with a voltage overshoot on restart.

FIG. 8 illustrates wireless power receiver operation during a pause in wireless power transfer to perform measurements characterizing the wireless link in a wireless power transfer system with soft restarting of an inverter of the wireless power transmitter to reduce a voltage overshoot on restart.

FIG. 9 illustrates a first configuration of inverter drive signals for soft restarting a wireless power transmitter inverter after a pause in wireless power transfer to perform measurements characterizing the wireless link in a wireless power transfer system with soft restarting of the inverter to reduce a voltage overshoot on restart.

FIG. 10A illustrates a schematic diagram of a ping signal injection circuit for use during a pause in wireless power transfer.

FIG. 10B illustrates switching signals associated with the ping signal injection circuit of FIG. 10A.

FIG. 11A illustrates a schematic diagram of an alternative ping signal injection circuit for use during a pause in wireless power transfer.

FIG. 11B illustrates switching signals associated with the alternative ping signal injection circuit of FIG. 11A.

FIG. 12 illustrates a schematic diagram giving an alternative view of a ping signal injection circuit as in FIG. 10A.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather, the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

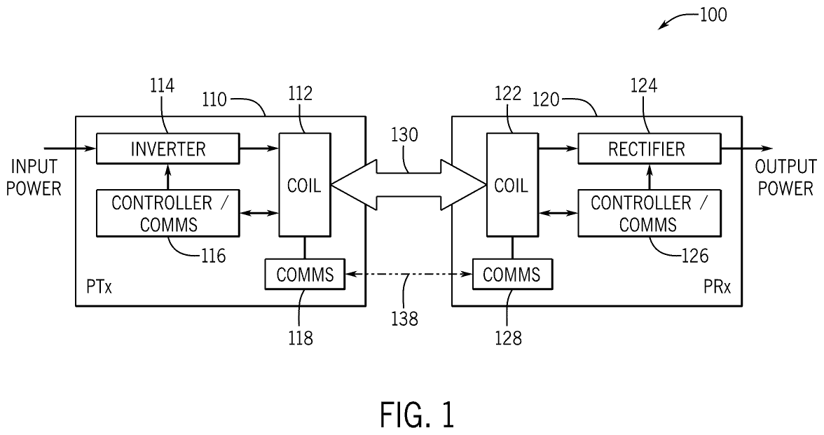

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by a controller/communications module 116 that operates as further described below. In various embodiments, the inverter controller and communications module may be implemented in a common system, such as a system based on a microprocessor, microcontroller, or the like. In other embodiments, the inverter controller may be implemented by a separate controller module and communications module that have a means of communication between them. Inverter 114 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

Inverter 114 may deliver the generated AC voltage to a transmitter coil 112. In addition to a wireless coil allowing magnetic coupling to the receiver, the transmitter coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transmitter coil may also include a core of magnetically permeable material (e.g., ferrite) configured to affect the flux pattern of the coil in a way suitable to the particular application. The teachings herein may be applied in conjunction with any of a wide variety of transmitter coil arrangements appropriate to a given application.

PTx controller/communications module 116 may monitor the transmitter coil and use information derived therefrom to control the inverter 114 as appropriate for a given situation. For example, controller/communications module may be configured to cause inverter 114 to operate at a given frequency or output voltage depending on the particular application. In some embodiments, the controller/communications module may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications module 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, controller/communications module may be configured to employ frequency shift keying (FSK) communications, in which the frequency of the inverter signal is modulated, to communicate data to the PRx. Controller/communications module 116 may be configured to detect amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 116 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry.

PTx device 110 may optionally include other systems and components, such as a separate communications module 118. In some embodiments, comms module 118 may communicate with a corresponding module in the PRx via the power transfer coils. In other embodiments, comms module 118 may communicate with a corresponding module using a separate physical channel 138.

As noted above, wireless power transfer system also includes a wireless power receiver (PRx) 120. Wireless power receiver can include a receiver coil 122 that may be magnetically coupled 130 to the transmitter coil 112. As with transmitter coil 112 discussed above, receiver coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless receiver coil may also include a core of magnetically permeable material (e.g., ferrite) configured to affect the flux pattern of the coil in a way suitable to the particular application. The teachings herein may be applied in conjunction with any of a wide variety of receiver coil arrangements appropriate to a given application.

Receiver coil 122 outputs an AC voltage induced therein by magnetic induction via transmitter coil 112. This output AC voltage may be provided to a rectifier 124 that provides a DC output power to one or more loads associated with the PRx device. Rectifier 124 may be controlled by a controller/communications module 126 that operates as further described below. In various embodiments, the rectifier controller and communications module may be implemented in a common system, such as a system based on a microprocessor, microcontroller, or the like. In other embodiments, the rectifier controller may be implemented by a separate controller module and communications module that have a means of communication between them. Rectifier 124 may be constructed using any suitable circuit topology (e.g., full bridge, half bridge, etc.) and may be implemented using any suitable semiconductor switching device technology (e.g., MOSFETs, IGBTs, etc. made using silicon, silicon carbide, or gallium nitride devices).

PRx controller/communications module 126 may monitor the receiver coil and use information derived therefrom to control the rectifier 124 as appropriate for a given situation. For example, controller/communications module may be configured to cause rectifier 124 to operate provide a given output voltage depending on the particular application. In some embodiments, the controller/communications module may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications module 126 may, for example, modulate load current or other electrical parameters of the received power to send information to the PTx. In some embodiments, controller/communications module 126 may be configured to detect and decode signals imposed on the magnetic link (such as voltage, frequency, or load variations) by the PTx to receive information from the PTx. In some embodiments, controller/communications module 126 may be configured to receive frequency shift keying (FSK) communications, in which the frequency of the inverter signal has been modulated to communicate data to the PRx. Controller/communications module 126 may be configured to generate amplitude shift keying (ASK) communications or load modulation-based communications from the PRx. In either case, the controller/communications module 126 may be configured to vary the current drawn on the receiver side to manipulate the waveform seen on the Tx coil to deliver information from the PRx to the PTx. For out-of-band communication, additional modules that allow for communication between the PTx and PRx may be provided, for example, WiFi, Bluetooth, or other radio links or any other suitable communications channel.

As mentioned above, controller/communications module 126 may be a single module, for example, provided on a single integrated circuit, or may be constructed from multiple modules/devices provided on different integrated circuits or a combination of integrated and discrete circuits having both analog and digital components. The teachings herein are not limited to any particular arrangement of the controller/communications circuitry. PRx device 120 may optionally include other systems and components, such as a communications (“comms”) module 128. In some embodiments, comms module 128 may communicate with a corresponding module in the PTx via the power transfer coils. In other embodiments, comms module 128 may communicate with a corresponding module or tag using a separate physical channel 138.

Numerous variations and enhancements of the above-described wireless power transmission system 100 are possible, and the following teachings are applicable to any of such variations and enhancements.

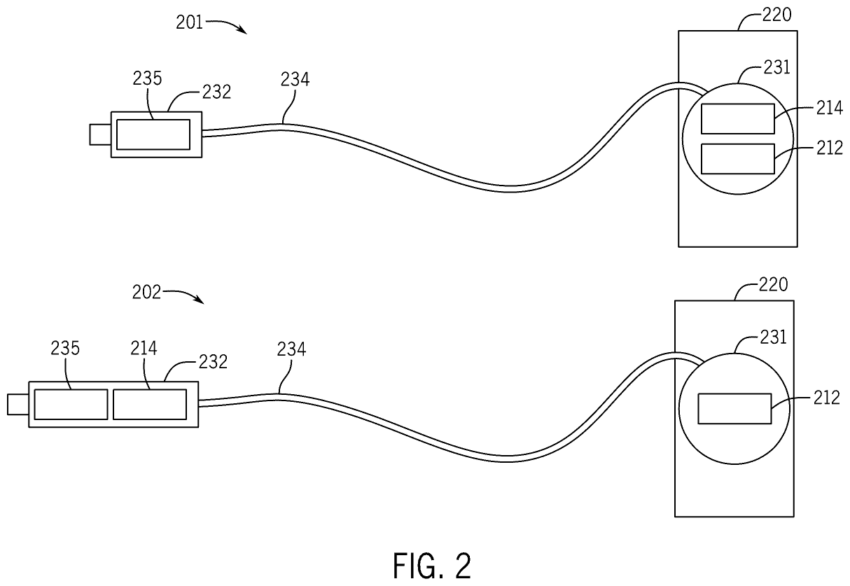

FIG. 2 illustrates alternative embodiments of a wireless charger device. More specifically wireless charger 201 is a wireless charger that can provide power to a wireless power receiver (PRx) device 220. The wireless charger 201 can have a puck 231 that can couple to the PRx 220, a cable 234, and a boot 232. In some embodiments, the puck 231 can be secured to the PRx 220 by magnets or other securing mechanisms. Boot 232 can include an electrical connection for coupling to a power source. For example, the electrical connection could be a USB (universal serial bus) connection that can couple to a corresponding USB port on a power adapter or on a device such as a desktop computer, laptop computer, tablet, etc. In some embodiments, the boot 232 can include a DC-DC converter 235 that converts a voltage received from the power source to a level suitable for use by the components in the puck 231. Components in the puck 231 can include an inverter (DC/AC converter) 214 and the wireless power transmitting coil 212. As described above, the wireless power transmitting coil 212 can couple to a corresponding wireless power receiving coil (not shown) in PRx 220.

The above-described arrangement results in a DC current flowing from the DC-DC converter 235, located in the boot 232 of wireless charger 201, to the inverter 214 located in the puck 231 of wireless charger 201. When constructed in this way, the power transfer capability to PRx 220 may be limited by thermal limitations associated with inverter 214 being located in puck 231. More specifically, there may be certain losses associated with operation of inverter 214, as well as certain losses associated with the wireless power receiving circuitry located in PRx 220 (as described above with reference to FIG. 1). In some cases, there may also be losses associated with charging of a battery (not shown) located in PRx 220. Each of these losses is located in relatively close physical proximity, and thus the combination of these losses can present thermal conditions that limit the amount of power that can be delivered to PRx 220 by wireless charger 201.

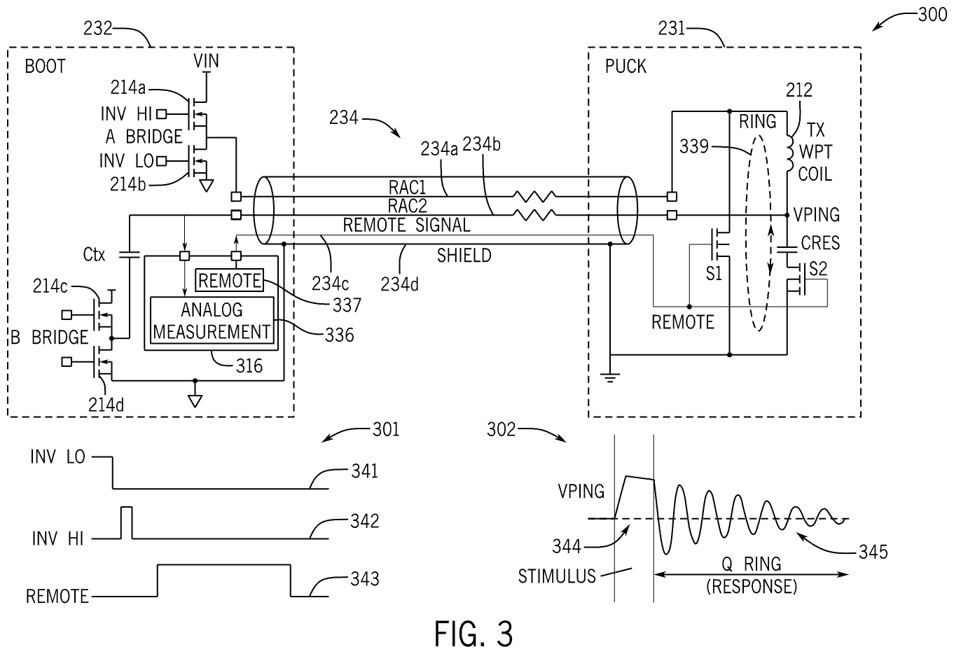

One way to address such losses can be to relocate inverter 214 from puck 231 to boot 232, as depicted with respect to wireless charger 202. As a result, the heat corresponding to losses associated with inverter operation can be moved from close proximity to the other losses described above, providing more headroom for increased levels of power transfer. This change in configuration results in an AC current (generated by inverter 214) being sent through cable 234. Additionally, puck 231 in such an embodiment includes power transmitting coil 212 as the only component of the wireless power transfer chain. It should be noted that other sensing and control components (i.e., non-power-carrying components) associated with the wireless power transfer system may still be located in puck 231, such as various components described above with respect to FIG. 1 and below with respect to FIG. 3.

Wireless power transfer systems may incorporate features that rely on a “ping” initiated by the wireless power transmitter to characterize the magnetic link between the wireless power transmitter and receiver, detect the presence of a wireless power receiver, detect the presence of a foreign object, etc. The general natures of these pings are that the wireless power transmitter provides some sort of stimulus signal to the resonant LC tank corresponding to the magnetic link. This will result in some sort of response, e.g., a ringing signal, that can be characterized in terms of its frequency, duration, decay envelope, etc. to identify electrical and/or magnetic characteristics of the magnetic link. For example, the Q-factor of the wireless power transmitter coil can be measured, which will be affected by various objects (such as a wireless power receiver and/or foreign object) that are magnetically and/or electrically coupled to the wireless power transmitter coil. In addition or as an alternative, parameters other than Q-factor can be measured, such as effective inductance, coupling coefficient, or other electrical, magnetic, and/or electromagnetic parameters or properties of the wireless link. These various parameters can be used for a variety of purposes, such as detecting the presence of a wireless power receiver, detecting the presence of a foreign object, detecting an object and determining whether the detected object is a wireless power receiver or a foreign object, estimating a degree of coupling or alignment between wireless power receiver and wireless power transmitter that can affect the level of power transfer, etc.

These pings initiated by the wireless power transmitter may be affected by the change in wireless charger configuration described above with reference to FIG. 2 in that the pings characterize the AC current path. By relocating the inverter from puck to boot, the cable 234 (now carrying an AC signal) becomes part of the AC circuit characterized by the ping signals. This can add an increased resistance associated with cable 234 that skews the measurements. Additionally, the impedance of the cable can change with use, aging, temperature, wear, etc. All of these factors can potentially make it harder to use such measurements for all desired purposes. Thus, it may be desirable in at least some embodiments to provide a mechanism to allow for “ping” measurements in a way that the additional impedance presented by the cable 234 can be eliminated.

FIG. 3 illustrates a simplified schematic of a wireless charger 300 capable of a remote ping that can eliminate the effects of cable impedance overcoming the issues described above. More specifically, wireless charger 300 includes a boot 232, a puck 231, and a cable 234, as described above with respect to FIG. 3. Boot 232 can include a DC-DC converter (not shown). Boot 232 can also include an inverter, illustrated in the form of two switching bridges (A Bridge and B Bridge) each made up of a high side switching devices (214a/214c) and low side switching devices (214b/214d). Other inverter topologies could also be used. Boot 232 can also include a resonant capacitor Ctx that can resonate with the wireless power transmitting coil 212 located in puck 231 during normal wireless power transfer operation. Additionally, boot 232 can include control circuitry 316, which, in addition to the components and functionality described above with respect to controller/communications module 116, can also implement analog measurement circuitry and logic 336 and remote ping control circuitry and logic 337, as described in greater detail below.

Cable 234 can include a cable for carrying power and signals between boot 232 and puck 231. Illustrated cable 234 includes two power conductors 234a and 234b, which couple the inverter to wireless power transmitter coil 212 located in the puck. Each of these conductors may have an associated impedance, depicted in FIG. 3 as AC resistances Rac1 and Rac2. In at least some embodiments, the AC resistance of these conductors may be considered as the predominant component of the cable's impedance; however, there may also be parasitic inductances and capacitances associated with the cable and its length. However, the effects of the impedance, of any nature, can be mitigated by the techniques described below. Cable 234 can also include a remote signal conductor 234c used as part of a remote ping process described in greater detail below. Cable 234 may also include other conductors used with sensing components (e.g., temperature sensors) or other components (not shown) that can be located in puck 231. Finally, cable 234 may also include a shield 234d, which may be coupled to the ground references for both boot 232 and puck 231.

Puck 231 can include wireless power transmitting coil 212 as described above. Wireless power transmitting coil 212 can be coupled to the inverter in boot 232 by cable 234, specifically conductors 234a/234b. Puck 231 can also include a capacitor Cres and switching devices S1 S2 used for remote ping operation. More specifically, during normal operation, switches S1 and S2 can be open, disconnecting capacitor Cres from the circuit and allowing normal operation. Switches S1 and S2 can be controlled by remote switch controller 337, which can be circuitry and or logic incorporated in control circuitry 316, as described above. Thus, during a remote ping operation, which can occur prior to wireless power transfer inverter operation or during a pause in wireless power transfer inverter operation may be paused (as described in greater detail below), remote switch controller 337 can close switches S1 and S2, effectively providing a current path 339 for a ringing signal in the resonant circuit formed by wireless power transmitter coil 212 and resonant capacitor Cres.

During this remote ping period, the ringing voltage at the terminal forming the junction between wireless power transmit coil 212 and resonant capacitor Cres can be measured via analog measurement circuitry and logic 336 (discussed above), to which this node is coupled by conductor 234b. Analog measurement circuitry and logic 336 may include an analog to digital converter (A/D converter) to convert the measured voltage into a digital value that can be used by one or more processors or other digital control circuits of control circuitry 316. Analog measurement circuitry 336 could also or alternatively include other signal conditioning circuitry (buffer amplifiers, error amplifiers, etc.) allowing the signal to be used by control circuitry 336. In any case, analog measurement circuitry 336 can present a very high impedance, such that little to no current flows in conductor 234b, such that the impedance associated with cable 234 does not affect measurements associated with the remote ping operation.

Also depicted in FIG. 3 are signal plots 301 and 302 illustrating further aspects of the remote ping operation. Plot 301 depicts the output 341 of inverter low side switch 214b, illustrating a switch off transition associated with cessation of inverter operation. Plot 301 further depicts the output 342 of inverter high side switch 214a, which can be a pulse providing the inverter input voltage Vin to the wireless power transmitter coil 212. This can be the “ping” or stimulus signal described above. Finally, plot 301 further depicts the output 343 of remote switch controller 337, which, after the stimulus signal, closes, providing the ringing current circulation path described above. Plot 302 illustrates the ringing signal Vping appearing at the junction between wireless power transmitter coil 212 and resonant capacitor Cres and measured by analog measurement circuitry and logic 336 via conductor 234b, as described above. The signal includes an initial portion 344, corresponding to the stimulus pulse, and a response portion 345, corresponding to the ringing period. This ringing signal, as measured by analog measurement circuitry and logic 316 can be processed to determine the Q factor of wireless power transmitter coil 212 or other electrical, magnetic, or electromagnetic properties that can be used to characterize the wireless link between wireless power transmitter and receiver, detect the presence of a wireless power receiver, detect the presence of a foreign object, etc.

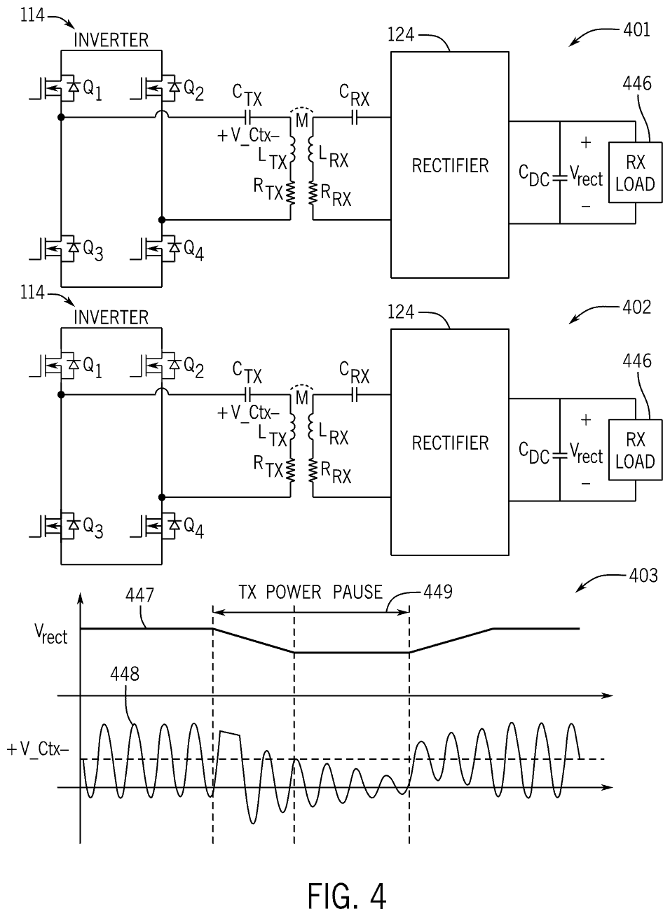

FIG. 4 illustrates a technique for pausing wireless power transfer to perform measurements characterizing the wireless link in a wireless power transfer system. FIG. 4 includes a first simplified schematic 401 depicting a wireless power transfer system in a normal power transfer operation. FIG. 4 also includes a second simplified schematic 402 depicting a wireless power transfer system in a power pause mode allowing for ringing of the resonant circuit to be measured. This measurement may, but need not, use a remote ping arrangement, as described above. FIG. 4 also depicts a plot 403 illustrating rectifier output voltage Vrect/447 and resonant capacitor voltage V_Ctx/448 during a power pause period 449.

Turning to the first schematic, a wireless power transfer system 401 in normal operation can include a wireless power transmitter and wireless power receiver as described above. The wireless power transmitter can include an inverter 114 including switching devices Q1-Q4. The illustrated topology is merely exemplary, and other inverter topologies could also be used. The wireless power transmitter can also include a wireless power transmitter coil, represented by the series combination of inductor L_{TX} and R_{TX}, corresponding to the inductance and resistance of the wireless power transmitter coil, respectively. The wireless power transmitter coil can be coupled to the inverter 114 by a resonant capacitor C_{TX}.

The wireless power receiver can include a rectifier 124, illustrated in block diagram form, which can include any of a variety of rectifier bridge configurations, such as half bridge, full bridge, etc. Additionally, the rectifier may include “passive” rectifier devices, e.g., diodes, or active rectifier devices, including switching devices such as MOSFETs, JFETs, IGBTs, BJTs, etc. The switching devices may be implemented using any suitable semiconductor technology, such as silicon (Si), silicon carbide (SiC), gallium nitride (GaN), etc. In at least one embodiment, rectifier 124 can be a full bridge active (synchronous) rectifier formed of MOSFET switches. The input of rectifier 124 can be coupled to the wireless power receiving coil, represented in FIG. 4 by the series combination of inductor L_{RX} and resistor R_{RX}, respectively corresponding to the inductance and resistance of the wireless power receiver coil. Rectifier 124 and the wireless power receiver coil can be coupled by a resonant capacitor C_{RX}. Magnetic coupling between the wireless power transmitter and wireless power receiver is represented by the mutual inductance M between inductors L_{TX} and L_{RX}. The output of rectifier 124 is a DC voltage Vrect that is provided to a receiver load 446. In some cases, receiver load 446 may be a further regulator/converter that provides one or more regulated voltage to a variety of receiver system loads. A rectifier output capacitor C_{DC} may be provided for output bus filtering, load holdup, etc.

With reference to the second schematic 402, the wireless power transfer system (including the same components as described a above with reference to schematic 401) can operate in a “power pause” mode to measure properties of the magnetic link between wireless power transmitter and receiver corresponding to the “ping” operation described above. This power pause includes stopping switching of the inverter switching devices Q1-Q4 to stop power delivery from the wireless power transmitter to the wireless power receiver. The power pause can additionally include opening upper switching devices Q1/Q2 and closing lower switching devices Q3/Q4, effectively short circuiting the resonant tank made up of capacitor C_{TX} and the wireless power receiver coil. In some embodiments, this short circuiting can be performed using remote ping arrangements as described above with respect to FIGS. 2 and 3. In either case, the stimulation provided to the resonant tank is the previous power transfer and its cessation for the power pause. This can be understood with reference to plot 403 of FIG. 4.

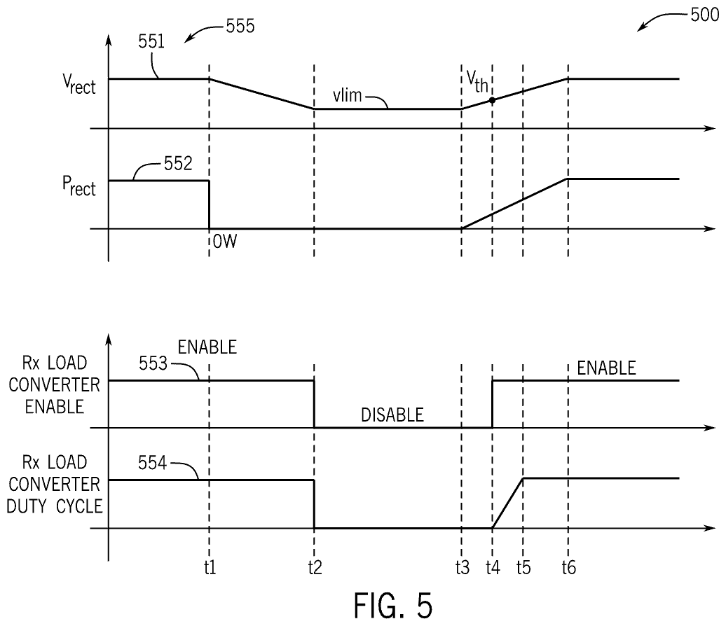

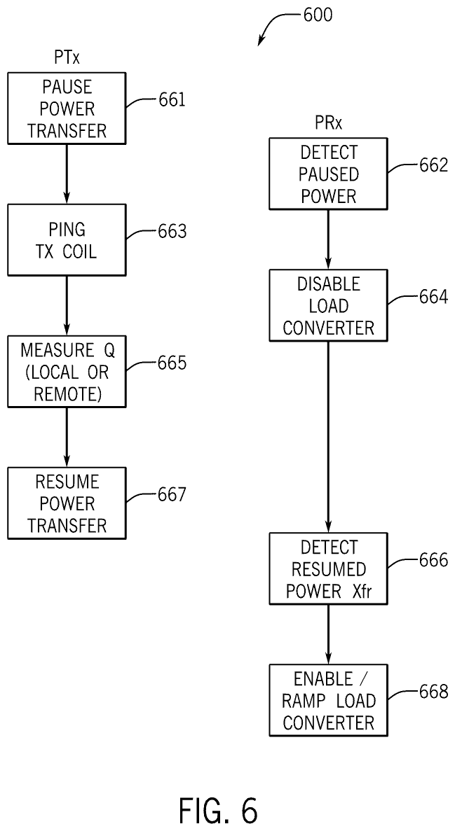

Plot 403 plots the rectifier output voltage V_{rect} as curve 447 and the V_Ctx, the voltage across the wireless power transmitter resonant capacitor C_{TX}, as curve 448. The power pause interval 449 begins when the inverter stops switching. Prior to this moment, V_{rect} can be at its nominal value, and the voltage V_Ctx can be a sinusoidal voltage with a DC offset. Once the inverter stops switching, V_Ctx begins a decayed ringing. Also, the DC offset of this signal is eliminated. During this same interval, V_{rect} also begins to decay. The wireless power receiver side circuitry can detect the power pause using various techniques described in greater detail below. When the wireless power receiver detects the power pause, it can control the receiver loads 446 to stop drawing power from the rectifier output/rectifier output capacitor C_{DC}. For example, a battery charger or other switching converter/regulator can be disabled. As a result, the decay of rectifier output voltage V_{rect} can be stopped, and V_{rect} can hold at a value below its nominal value. After the wireless power transmitter has completed its measurements characterizing the magnetic link between wireless power transmitter and receiver, it can resume normal operation, restoring normal switching of the inverter. This results in restoration of the DC offset in curve 448, as well as reversal of the decaying/ringing signal, by returning V_Ctx to its normal DC offset sinusoidal form. Additionally, rectifier output voltage V_{rect} will begin increasing, eventually returning to its nominal value. Contemporaneously therewith, the wireless power receiver can detect the end of the power pause using various techniques described in greater detail below and allow receiver load 446 to resume normal operation. Further details of these power pause operations are described in greater detail below with reference to FIGS. 5 and 6.

FIG. 5 illustrates wireless power receiver operation during a pause in wireless power transfer allowing the wireless power transmitter to perform measurements characterizing the wireless link in a wireless power transfer system. The illustration of FIG. 5 includes a plot 500 of various receiver-side waveforms. The first plotted waveform 551 is the rectifier output voltage Vrect, as described above with reference to FIG. 4. The second plotted waveform 552 illustrates power drawn from the rectifier (Prect), for example by receiver load 446 as described above. The third plotted waveform 553 is an exemplary enable/disable signal for the receiver load 446, which for purposes of this example is a switching regulator/converter that converts the rectifier output to one or more regulated voltages or currents for various other loads. In some embodiments, this might be a battery charger, but could also be another converter/regulator. The fourth plotted waveform 554 is an exemplary switching duty cycle of the receiver load 446.

Prior to time t1, which marks the beginning of the power pause interval, the wireless power transfer system can be operating in a normal power transfer mode 555. As such, rectifier output voltage Vrect can be at its nominal value. This nominal value can be determined based on system requirements, available input voltage, power transfer level, and other factors. In some embodiments, it may be a voltage of 28V, but other voltages such as 5V, 9V, 10V, 12V, 15V, 18V, 19V, 20V, 24V, 25V, 30V, etc. may be used as appropriate. Also, during this interval before time t1, the power drawn from the rectifier can be at a nominal value required by the wireless power receiver and its associated systems. In some embodiments, this could correspond to a power level of 5 W, 7.5 W, 10 W, 12 W, 15 W, 20 W, 25 W, 30 W, 35 W, 4 0W, 50 W, etc. Likewise, the receiver load converter may be enabled during this time period, and the receiver load converter may be operating with a duty cycle corresponding to its input voltage (i.e., the rectifier output voltage Vrect), its output voltage(s) and/or current(s), the power required by the various loads downstream of the converter, etc.

At time t1, the power pause interval may be initiated by the wireless power transmitter ceasing normal inverter switching and shorting the wireless power transmitter coil to measure properties of the electromagnetic link between wireless power transmitter and receiver. As a result, the power drawn from the rectifier ceases, as indicated by curve 552. During the power pause interval, no power is delivered from the wireless power transmitter to the wireless power receiver. However, the receiver load converter remains enabled, as indicated by curve 553, and the receiver load converter duty cycle continues at its nominal value determined by downstream load requirements as described above. This results in a decay of the rectifier output voltage Vrect as the output capacitor VDC is supplying the energy required by the receiver load 446.

At time t2, the rectifier output voltage will have decayed to a lower limit value vlim as a result of the receiver loads continuing to draw power from the rectifier output capacitor VDC. At time t2, the receiver can detect the power pause and disable the receiver load converter (as indicated by curve 553), which will result in the receiver load converter having a zero duty cycle (as indicated by curve 554). In some embodiments, load shedding can be achieved in other ways than a zero duty cycle, for example in embodiments in which load converter 446 is not a switching converter. The receiver controller (for example, the receiver side controller/communications module 126 described above) can perform both this detection of the power pause and the corresponding shutdown of the receiver load, such as receiver load converter 446.

The receiver controller can detect the power pause in various ways. For example, the receiver controller can detect the decay of the rectifier output voltage Vrect to the reduced level vlim. This value might be a fixed voltage value less than the nominal rectifier output voltage or may be a percentage of the nominal rectifier output voltage. As one example, for a 28V nominal Vrect voltage, the vlim limit voltage might be 23.5V, although other values are also possible. Such values might be 90%, 85%, 80%, 75%, 70%, etc. of the nominal voltage, or any other suitable value in a particular embodiment, such as percentages between any of the foregoing, e.g., between 85-90%, 80-85%, 75-80%, 70-75%, etc.

The receiver controller could also detect the cessation of switching of active/synchronous rectifier 124 or other signals resulting from the power pause. Such signals might include, but are not limited to as a change in the nature of the waveform appearing across the wireless power receiver coil (L_{RX}/R_{RX}) and/or receiver capacitor C_{RX}, such as a decreased voltage or current level, change in frequency, or change in waveform shape (e.g., from a square wave associated with normal switching to a sine wave associated with the power pause/ring-down on the transmitter side). In some embodiments, the receiver controller could also receive a communication from the wireless power transmitter indicating the power pause; however, in some cases, in-band communication between wireless power transmitter and receiver may be sufficiently slow that it would be necessary for the transmitter to notify (or begin notifying) the wireless power receiver in advance of the power pause to allow time to send the packets/bits required to convey such a message. Thus, it may be preferable for the wireless power receiver controller to be able to detect the power pause based on characteristics of one or more power transfer voltages, currents, or frequencies, without relying on a normal in-band communication mechanism.

At time t3, when the wireless power transmitter has completed its measurements, it can resume normal inverter operation and wireless power transfer. In some embodiments, the time required for the power pause may be on the order of 10 s to low 100 s of microseconds, although other intervals are possible. Such a short duration suggests the desirability of the receiver detecting the power pause directly, rather than relying on a communication from the wireless power transmitter, which might take somewhat longer than the pause depending on the in-band communications implementation. In any case, the resumption of inverter switching and wireless power transfer can cause the rectifier output voltage (Vrect) and power drawn from the rectifier (Prect) to begin ramping up as illustrated by curves 551 and 552 in the interval between t3 and t4 in FIG. 5. In this interval, the power drawn from the rectifier is recharging the rectifier output capacitor C_{DC}. At time t4, the wireless power receiver (i.e., receiver control circuitry) can detect that wireless power transfer has resumed. One possible trigger for such detection could be the increase of rectifier output voltage Vrect to a threshold value Vth that is greater than the lower limit value vlim but lower than the nominal value of Vrect (e.g., the value prior to the power pause). In some embodiments, such as the 28V embodiment referenced above, the threshold voltage Vth could be 26V, although other suitable values may be used, including values in the percentage ranges described above.

In any case, detection of this increase, can trigger the wireless power receiver controller to re-enable the receiver load converter, as indicated by curve 553. This decision could also (alternatively or additionally) be triggered by a time-delay after the rectifier output voltage Vrect or output power Prect begin increasing, by a detection of other voltage, current, frequency, or waveshape characteristic indicating resumption of wireless power transfer. As a result, during the interval from time t4 (when the receiver controller detects resumption of wireless power transfer) until t5, the receiver controller can ramp up the switching duty cycle of the receiver load converter sufficiently quickly to avoid an overshoot/overvoltage of the rectifier output voltage. This can be accomplished in various ways, such as by the receiver controller storing the pre-power pause duty cycle value and using it as a feed forward signal to accelerate ramp up of the load converter duty cycle. In either case, it may be desirable for the load converter to have resumed its nominal power transfer level before complete recovery of the rectifier output voltage (Vrect) and rectifier output power (Prect), which corresponds to the interval between times t5 and t6 in FIG. 5.

FIG. 6 illustrates a simplified flow chart 600 of wireless power transmitter (PTx) and wireless power receiver (PRx) operation during a pause in wireless power transfer to perform measurements characterizing the wireless link in a wireless power transfer system. Beginning with block 661, the wireless power transmitter can pause power transfer. The wireless power transmitter can then “ping” the wireless power transmitter coil (block 663). This “ping” can include providing a stimulus signal to the coil, e.g., using the inverter. In some cases, the stimulus signal can be the cessation of wireless power transfer itself. Thereafter (block 665), the wireless power transmitter can measure Q-factor or other electrical, magnetic, or electromagnetic property that characterizes the link between the wireless power transmitter and wireless power receiver. These measurements can be made using the remote ping techniques described above or by shorting the wireless power transmitting coil using the inverter switches.

In either case, the resulting measurements and characterizations can subsequently be used to detect the presence of a wireless power receiver and/or a foreign object and set an appropriate wireless power transfer level based at least in part thereon. Additionally or alternatively, these measurements and characterizations can be used to determine a degree of coupling between wireless power transmitter and wireless power receiver and set an appropriate power transfer level based at least in part thereon. After completing the measurements/characterizations, the wireless power transmitter can resume wireless power transfer (block 667). These PTx side operations can be performed by control circuitry associated with the wireless power transmitter, such as controller/communications module 116, discussed above.

On the receiver (PRx) side, once the transmitter (PTx) has paused power transfer, the receiver can detect the pause in power transfer (block 662). This can be substantially contemporaneous with the ping initiated by the transmitter and/or the measurements made on the wireless power transmitter side. In any case, after detecting the power pause, the wireless power receiver controller can disable the load converter (block 664). As described above, this can be responsive to various signals measured by the receiver controller on the receiver side without receiving a communication from the wireless power transmitter. Once the wireless power transmitter has resumed wireless power transfer (block 667), the receiver controller can detect resumed power transfer (block 666) and, responsive thereto, can re-enable and ramp up the load converter (block 668), as described above. These PRx side operations can be performed by control circuitry associated with the wireless power transmitter, such as controller/communications module 126, discussed above.

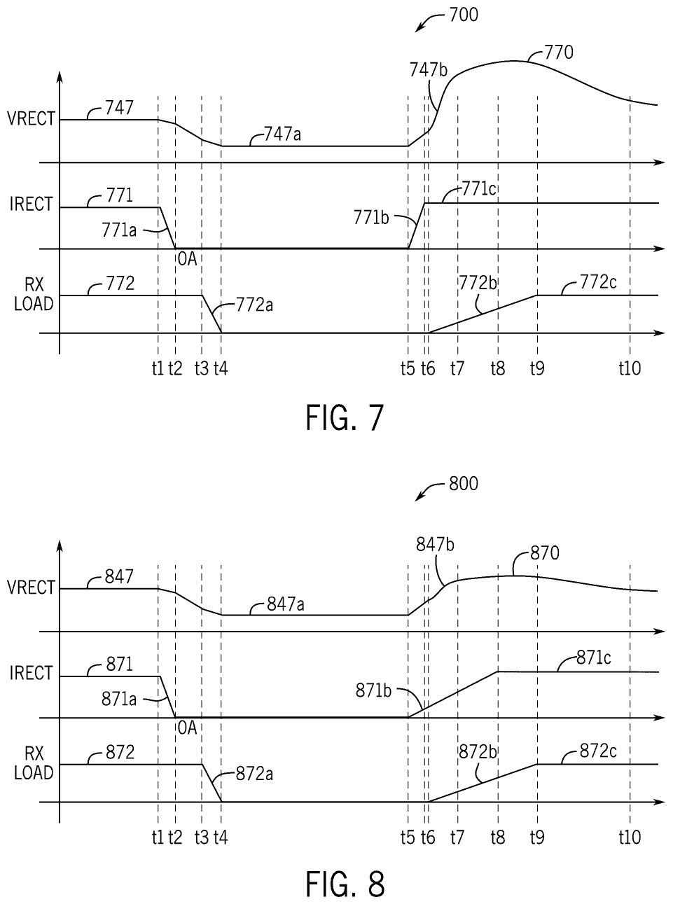

In some applications, resuming wireless power transfer after the pause to measure Q or other relevant parameters can result in a voltage overshoot on the receiver (PRx) side. FIG. 7 illustrates wireless power receiver operation during a pause in wireless power transfer to perform measurements characterizing the wireless link in a wireless power transfer system with a voltage overshoot on restart. FIG. 7 includes a plot 700 showing, as a function of time, PRx rectifier voltage Vrect (curve 747), rectifier current Irect (curve 771), and Rx load (curve 772). Prior to time t1, the system is transferring power normally, and each of these values may be at a constant/steady state value. At time t1, the transmitter (Ptx) can initiate a power pause as described above. Thus, the rectifier voltage Vrect decreases over time t2, t3, t4, until reaching a minimum value 747a. Substantially contemporaneously with the decrease in rectifier voltage Vrect, the rectifier current Irect also decreases (curve segment 771a), reaching 0A at time t2. Again, substantially contemporaneously with the decrease in rectifier voltage, the receiver load also decreases (curve segment 772a). In at least some embodiments, the receiver load decrease 772a can be later in time than the rectifier current decreases, for example as various energy-storing capacitances are discharged as Vrect decreases and/or a time delay allowing the wireless power receiver to detect a power pause and reduce load.

The interval from time t4 until t5 is the power pause described above, which can also be called a “slot” for measuring Q or other parameters associated with the wireless power link between the PTx and PRx. At the end of this pause or slot, i.e., t5, the PTx can resume power transfer. This results in an increase in Vrect from its minimum value back toward the value it had prior to the pause or slot, as illustrated by curve segment 747b. Also at t5, the rectifier current Irect will begin increasing, in association with the increases in rectifier voltage Vrect, as illustrated by curve segment 771b, reaching its prior/nominal value 771c at time t6. Once the rectifier current Irect has recovered, e.g., at time t6, the receiver load can also begin increasing 772b until recovering to its nominal value 772c at time t9.

Depending on transmitter and receiver electrical and magnetic properties and the load prior to the power pause or slot, resuming power transfer can result in an overshoot of the rectifier voltage during the resumption of power transfer, as illustrated by voltage peak 770 of the rectifier voltage Vrect. In some instances, this could be undesirable, for example by triggering an overvoltage protection mechanism or by requiring devices with higher voltage ratings than are otherwise required, etc. Thus, it may be desirable to mitigate this overvoltage by performing a soft restart following the power pause or slot.

FIG. 8 illustrates wireless power receiver operation during a pause in wireless power transfer to perform measurements characterizing the wireless link in a wireless power transfer system with soft restarting of an inverter of the wireless power transmitter to reduce a voltage overshoot on restart. Reference numbers in FIG. 8 generally correspond to reference numbers in FIG. 7. Thus, FIG. 8 includes a plot 800 showing, as a function of time, PRx rectifier voltage Vrect (curve 847), rectifier current Irect (curve 871), and Rx load (curve 872). Prior to time t1, the system is transferring power normally, and each of these values may be at a constant/steady state value. At time t1, the transmitter (Ptx) can initiate a power pause as described above. Thus, the rectifier voltage Vrect decreases over time t2, t3, t4, until reaching a minimum value 847a. Substantially contemporaneously with the decrease in rectifier voltage Vrect, the rectifier current Irect also decreases (curve segment 871a), reaching OA at time t2. Again, substantially contemporaneously with the decrease in rectifier voltage, the receiver load also decreases (curve segment 872a). In at least some embodiments, the receiver load decrease 872a can be later in time than the rectifier current decreases, for example as various energy-storing capacitances are discharged as Vrect decreases and/or a time delay allowing the wireless power receiver to detect a power pause and reduce load.

The interval from time t4 until t5 is the power pause described above, which can also be called a “slot” for measuring Q or other parameters associated with the wireless power link between the PTx and PRx. At the end of this pause or slot, i.e., t5, the PTx can resume power transfer. This results in an increase in Vrect from its minimum value back toward the value it had prior to the pause or slot, as illustrated by curve segment 847b. Also at t5, the rectifier current Irect will begin increasing, in association with the increases in rectifier voltage Vrect, as illustrated by curve segment 871b. However, unlike the example of FIG. 7, the soft restart can slow the increase in rectifier current Irect, such that instead of returning to its prior/nominal value 871c at time t6 (as above), this can take a longer time, e.g., until time t8. Notwithstanding this slowed ramp-up of rectifier current, at time t6, the receiver load can begin increasing 872b until recovering to its nominal value 872c at time t9.

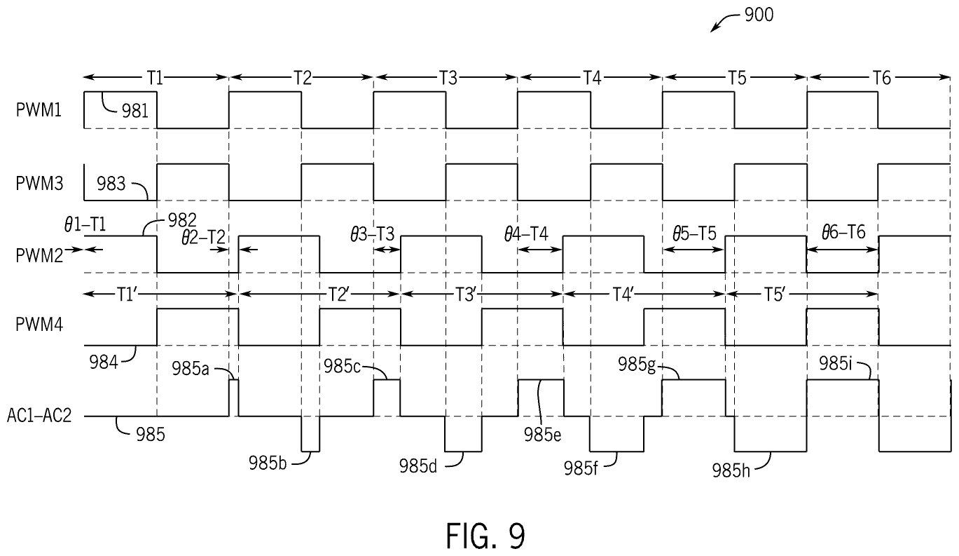

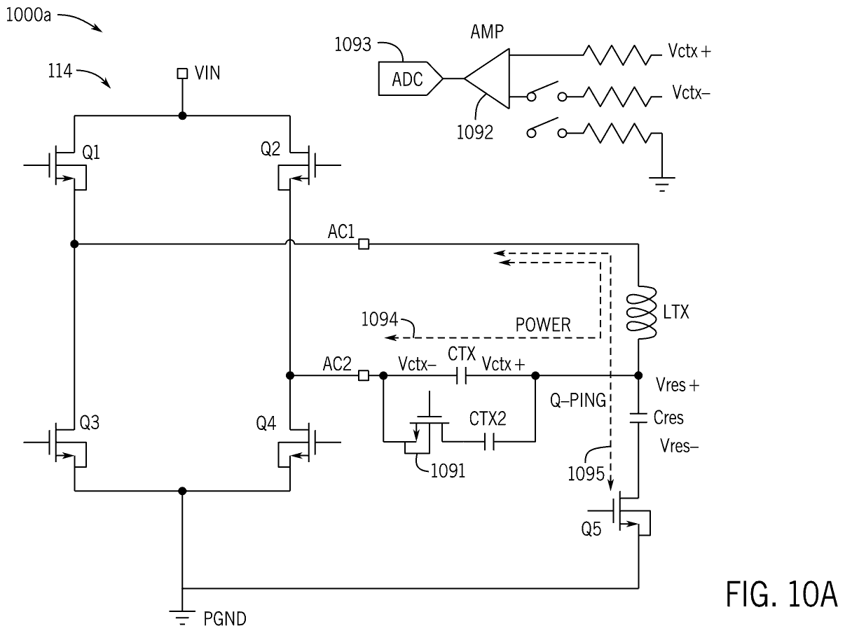

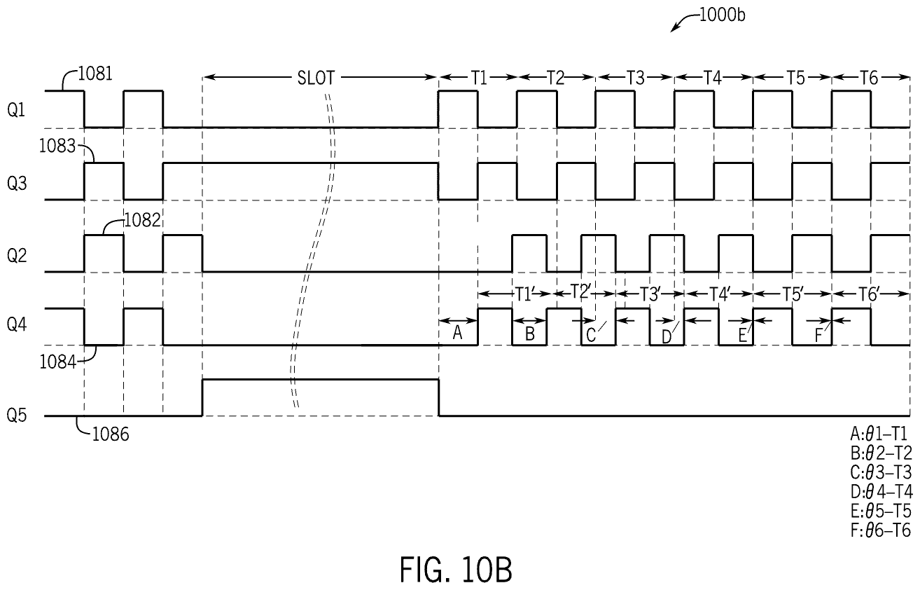

This slowed ramp up of rectifier current Irect can be achieved by modulating the phase of the drive signals supplied to the inverter as described below with reference to FIGS. 9 and 10. However, with continued reference to FIG. 8, it can be seen that the slower ramp up of the rectifier current corresponds with a decreased magnitude of the voltage peak 870 as compared to the example of FIG. 7, without a soft restart. This can mitigate potentially undesirable effects of a higher voltage peak on power resumption, as described above.

FIG. 9 illustrates a first configuration of inverter drive signals for soft restarting a wireless power transmitter inverter after a pause in wireless power transfer to perform measurements characterizing the wireless link in a wireless power transfer system with soft restarting of the inverter to reduce a voltage overshoot on restart. FIG. 9 includes a plot 900, showing a series of switching signals associated with the inverter 114 of a wireless power transmitter. As described above with reference to FIG. 4, inverter 114 can be a full bridge inverter made up of a first switching bridge half bridge including switches Q1 and Q3 and a second switching half bridge including switches Q2 and Q4. The switches can be controlled using pulse width modulation (PWM) signals, which can be generated using various appropriate control loops and other circuitry (e.g., controller and communication circuitry 116, described above). In plot 900 of FIG. 9, PWM enable signals PWM1/981 for switch Q1, PWM2/982 for switch Q2, PWM3/983 for switch Q3, and PWM4/984 for switch Q4 are illustrated during the soft restart sequence. As illustrated, each half bridge operates as a complementary switch pair. That is, when switch Q1 is turned on, switch Q3 is turned off, and vice-versa. Likewise, when switch Q2 is turned on, switch Q4 is turned off, and vice-versa. The soft restart sequence is illustrated as taking place over six time intervals T1-T6 (with reference to the first half bridge, also denoted T1′-T6′ with reference to the second half bridge); however, this number of intervals is merely exemplary and more or fewer intervals could. be provided.

The output voltage of a full bridge inverter, such as inverter 114 of FIG. 4, can be regulated by controlling the phase between the respective half bridges of the full bridge. That is, when the respective switching half bridges are operated 180 degrees out of phase, such that a high side switch of one half bridge (e.g., switch Q1) is enabled at the same time as a low side switch of the other half bridge (e.g., switch Q4), then a maximum inverter voltage is provided. Conversely, when the respective switching half bridges are operated in phase, such that a high side switch of one half bridge (e.g., switch Q1) is enabled at the same time as a high side switch of the other half bridge (e.g., switch Q2), then a minimum (or zero) inverter voltage is provided. Phase differences between these two values can thus regulate the output voltage produced by the inverter.

Thus, to achieve a soft restart, the phase between the respective half bridges can be increased from zero (i.e., in phase operation) during a first interval T1 to 180 degrees during time interval T6, with the phase gradually increasing through intervals T2-T5. In some embodiments, the initial phase need not start at zero but could instead start from any other initial phase less than 180 degrees. In any case, each interval has a phase difference θn-Tn (where n is the interval number), with the phase difference increasing from interval T1 until reaching its maximum in interval T6. This correspondingly results in an AC output voltage AC1-AC2, plotted in curve 985. During interval T1, with zero phase between the respective half bridges, there is no output voltage from the inverter. During interval T2, with increasing phase, there is a short interval 985a corresponding to a positive half cycle of the inverter output voltage and a slightly longer, but still relatively short interval 985b corresponding to a negative half cycle of the inverter output voltage. These shortened intervals correspond to a reduction in the inverter output voltage. Moreover, these intervals continue increasing through intervals T3-T5, finally reaching their maximum at interval T6, when the respective half bridges are operating 180 degrees out of phase. Phase shift modulation as described herein is not the only technique for achieving soft restart. Soft restart could also be accomplished using other techniques, e.g., increasing duty cycle, etc.

As described above with reference to FIGS. 3 and following, a ping signal may be used during a pause in wireless power transfer to measure Q-factor or other parameters of the wireless link between a wireless power transmitter (PTx) and a wireless power receiver (PRx). One exemplary circuit arrangement for generating such a ping signal was described with reference to FIG. 3. An alternative arrangement is illustrated in FIG. 10A. More specifically, FIG. 10A illustrates a schematic diagram 1000a of a ping signal injection circuit for use during a pause in wireless power transfer. Although FIG. 3 discloses one potential arrangement of various circuit components with respect to a boot, cable, and puck of a wireless charger device, the arrangement shown in FIG. 10A is more general. Thus, respective components can be arranged in separate parts of a device or in a single part of a device, as appropriate for a given embodiment.

FIG. 10A illustrates a simplified diagram inverter 114, made up of switches Q1-Q4 in a full-bridge configuration, as described above with reference to FIG. 4. The DC input to the inverter can be provided between the VIN terminal and the ground terminal PGND, with the AC output being taken across terminals AC1 and AC2. The wireless power transfer coil (represented by inductor L_{TX}) and tuning capacitance arrangement (represented by capacitors CTX and CTX2 and switch 1091) can be connected in series between terminals AC1 and AC2. The tuning capacitance arrangement can be used to present two different tuning capacitances, e.g., for wireless power transfer operation at different frequencies and/or different power levels. Thus, when switch 1091 is open, the tuning capacitance will be CTX, while when switch 1091 is closed, the tuning capacitance will be CTX+CTX2.

Also illustrated in FIG. 10A is ping signal generating circuitry including a resonant capacitor Cres and switch Q5 connected in series between the junction of wireless power transfer coil LTx with the tuning capacitance and ground. Additionally, the response to the ping signal can be measured between tuning capacitor terminal Vctx+ and ground (i.e., the single-ended connection to amplifier 1092). For control purposes other than the ping signal response measurement, the differential connection in which tuning capacitor terminals Vctx+ and Vctx− are connected to respective inputs of amplifier 1092 can be used, such that the voltage across the tuning capacitance can be measured. In either case, the output of this amplifier can be coupled to an analog to digital converter 1093, which can then provide digital representations of this voltage to the control circuitry (e.g., control and communication circuitry 116) of the wireless power transmitter. The amplifier can also have a variable/controllable gain to deal with different input signal levels. This arrangement thus provides a power path 1094 for the wireless power, with a separate path 1095/Q-PING for the ping signal used to measure Q and/or other circuit parameters during a power pause or slot, as described above.

FIG. 10B illustrates a plot 1000b depicting switching signals associated with the ping signal injection circuit of FIG. 10A. Drive signals 1081-1084 correspond to inverter switches Q1-Q4 as described above with reference to FIG. 9. Drive signal 1086 corresponds to switch Q5. Thus, initially, i.e., prior to the power pause or slot, switches Q1 and Q4 are turned on at the same time—corresponding to a positive half cycle of the AC inverter output, and switches Q2 and Q3 are turned on at the same time—corresponding to a negative half cycle of the AC inverter output. Then, when the inverter is switched off, beginning the power pause or slot, switches Q3 and Q5 can be enabled to “ping” the resonant circuit allowing measurement of Q and/or other circuit parameters. Then, at the end of the power pause or slot, switch Q5 can be disabled, and power transfer can resume, e.g., using the soft start sequence described above. However, use of the ping signal injection circuit depicted in FIG. 10A need not necessarily include use of the soft restart technique or vice-versa. Thus, the ping signal generating and measuring circuitry depicted in FIG. 10A can be, but need not be, completely independent of the soft restart technique described with reference to FIGS. 7-9.

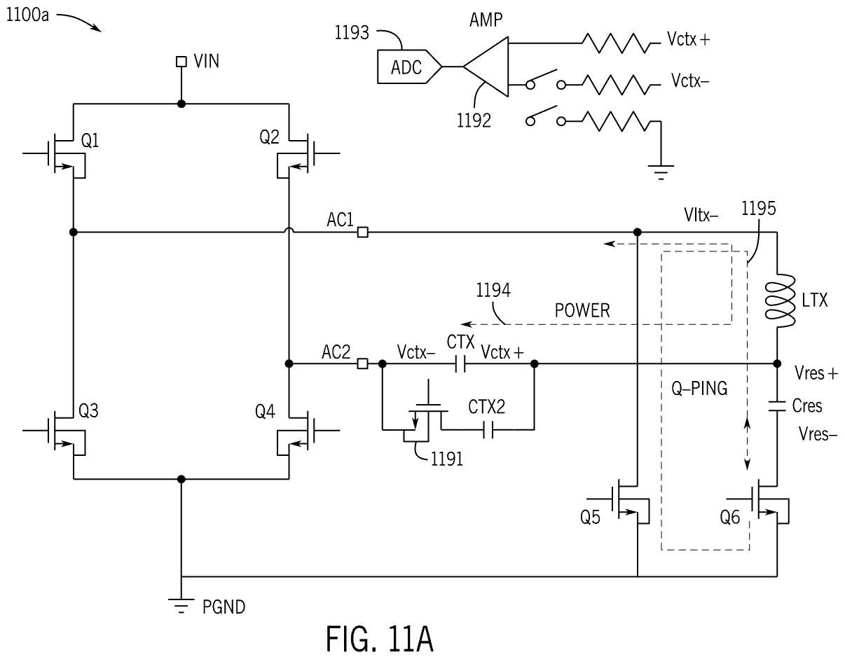

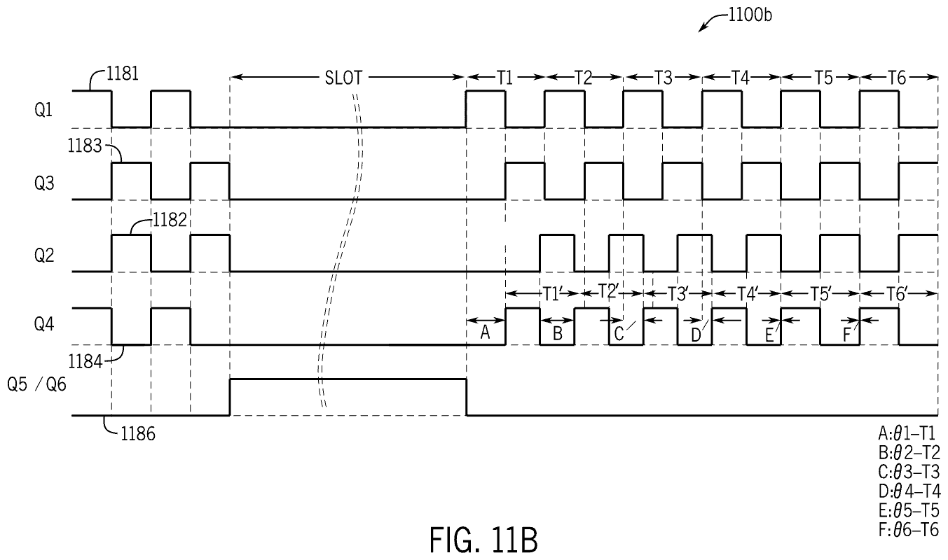

FIG. 11A illustrates a schematic diagram 1100a of an alternative ping signal injection circuit for use during a pause in wireless power transfer. Although FIG. 3 discloses one potential arrangement of various circuit components with respect to a boot, cable, and puck of a wireless charger device, the arrangement shown in FIG. 11A is more general. Thus, respective components can be arranged in separate parts of a device or in a single part of a device, as appropriate for a given embodiment.

FIG. 11A illustrates a simplified diagram inverter 114, made up of switches Q1-Q4 in a full-bridge configuration, as described above with reference to FIG. 4. The DC input to the inverter can be provided between the VIN terminal and the ground terminal PGND, with the AC output being taken across terminals AC1 and AC2. The wireless power transfer coil (represented by inductor LTX) and tuning capacitance arrangement (represented by capacitors CTX and CTX2 and switch 1191) can be connected in series between terminals AC1 and AC2. The tuning capacitance arrangement can be used to present two different tuning capacitances, e.g., for wireless power transfer operation at different frequencies and/or different power levels. Thus, when switch 1191 is open, the tuning capacitance will be CTX, while when switch 1191 is closed, the tuning capacitance will be CTX+CTX2.

Also illustrated in FIG. 11A is ping signal generating circuitry including a resonant capacitor Cres and switches Q5 and Q6. Resonant capacitor Cres and switch Q6 are connected in series between the junction of wireless power transfer coil LTX with the tuning capacitance and ground. Switch Q5 is connected between connected between inverter output terminal AC1 and ground. Additionally, the response to the ping signal can be measured between tuning capacitor terminal Vctx+ and ground (i.e., the single-ended connection to amplifier 1192). For control purposes other than the ping signal response measurement, the differential connection in which tuning capacitor terminals Vctx+ and Vctx− are connected to respective inputs of amplifier 1192 can be used, such that the voltage across the tuning capacitance can be measured. In either case, the output of this amplifier can be coupled to an analog to digital converter 1193, which can then provide digital representations of this voltage to the control circuitry (e.g., control and communication circuitry 116) of the wireless power transmitter. The amplifier can also have a variable/controllable gain to deal with different input signal levels. This arrangement thus provides a power path 1194 for the wireless power, with a separate path 1195/Q-PING for the ping signal used to measure Q and/or other circuit parameters during a power pause or slot, as described above.

FIG. 11B illustrates a plot 1100b depicting switching signals associated with the alternative ping signal injection circuit of FIG. 11A. Drive signals 1181-1184 correspond to inverter switches Q1-Q4 as described above with reference to FIG. 9. Drive signal 1186 corresponds to switches Q5/Q6. Thus, initially, i.e., prior to the power pause or slot, switches Q1 and Q4 are turned on at the same time—corresponding to a positive half cycle of the AC inverter output, and switches Q2 and Q3 are turned on at the same time—corresponding to a negative half cycle of the AC inverter output. Then, when the inverter is switched off, beginning the power pause or slot, switches Q5 and Q6 can be enabled to “ping” the resonant circuit allowing measurement of Q and/or other circuit parameters. Then, at the end of the power pause or slot, switches Q5 and Q6 can be disabled, and power transfer can resume, e.g., using the soft start sequence described above. However, use of the ping signal injection circuit depicted in FIG. 11A need not necessarily include use of the soft restart technique or vice-versa. Thus, the ping signal generating and measuring circuitry depicted in FIG. 11A can be, but need not be, completely independent of the soft restart technique described with reference to FIGS. 7-9.

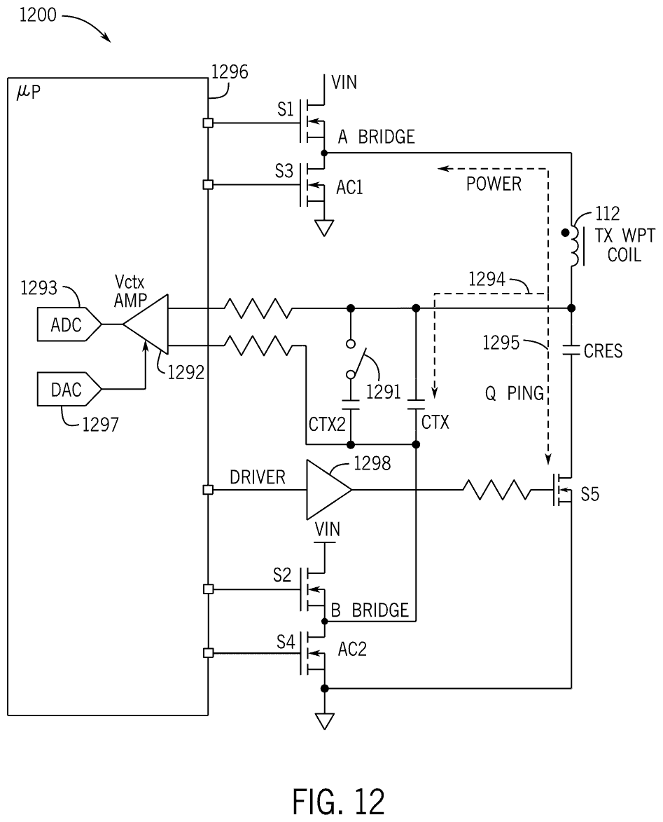

FIG. 12 illustrates a schematic diagram 1200 giving an alternative view of a ping signal injection circuit as in FIG. 10A. FIG. 10A illustrates inverter 114 separated into respective half bridges and made up of switches S1-S4 in a full-bridge configuration, as described above with reference to FIG. 4. Thus, switches SI and S3 (corresponding to Q1 and Q3 described above) form a first half bridge designated the A bridge, and switches S2 and S4 (corresponding to Q1 and Q4 described above) form a second half bridge designated the B bridge. The DC input to the inverter can be provided between the VIN terminal and the ground terminal PGND, with the AC output being taken across terminals AC1 and AC2. Drive signals for the inverter switches S1-S4 can be provided by a microprocessor or microcontroller 1296, which can form all or part of the control and communication circuitry 116 described above with respect to FIG. 1.

The wireless power transfer coil 112 and tuning capacitance arrangement (represented by capacitors CTX and CTX2 and switch 1291) can be connected in series between terminals AC1 and AC2. The tuning capacitance arrangement can be used to present two different tuning capacitances, e.g., for wireless power transfer operation at different frequencies and/or different power levels. Thus, when switch 1291 is open, the tuning capacitance will be CTX, while when switch 1091 is closed, the tuning capacitance will be CTX+CTX2.

Also illustrated in FIG. 12 is ping signal generating circuitry including a resonant capacitor Cres and switch S5 (corresponding to Q5 above in FIG. 10A) connected in series between the junction of wireless power transfer coil 112 with the tuning capacitance and ground. Switch S5 can be driven by microprocessor/microcontroller 1296 via driver 1298. Additionally, the response to the ping signal can be measured across the tuning capacitor arrangement. For example, amplifier 1292, which can be part of microprocessor/microcontroller 1296 can be coupled to respective terminals of the tuning capacitance arrangement, such that the voltage across the tuning capacitance can be measured. The output of this amplifier can be coupled to an analog to digital converter 1293, which can also be part of the microprocessor/microcontroller 1296, thus providing digital representations of this voltage to the control circuitry of the wireless power transmitter. This arrangement thus provides a power path 1294 for the wireless power, with a separate path 1295/Q-PING for the ping signal used to measure Q and/or other circuit parameters during a power pause or slot, as described above.

The operations described above refer to various voltage levels and thresholds, power levels and thresholds, etc. The descriptions herein may be applied to various systems operating at different voltage levels, different power levels, etc. For example, in some embodiments, the input voltage may be controllable to be in a range between about 16V and 20V, whether by manipulation of the control signal for a DC-DC converter or otherwise. Such a voltage range may, but need not, correspond to a USB-PD power source providing a 20V input voltage to such DC-DC converter. However, operation in other voltage ranges corresponding to other USB-PD voltage levels may also be appropriate. For example, an input voltage range between about 10V and 15V or 12V and 15V may be used with a 15V USB-PD supply. Alternatively, if a buck-boost converter were used to provide Vin from the power source, the top of the supplied voltage range could go above the voltage supplied to such DC-DC converter. Similarly, with respect to power thresholds, a 15 W power threshold may serve as the demarcation between a low power regime and a higher power regime. Operating above this threshold could be used to selectively enable or disable functionality such as the input voltage reduction before initiating a change in capacitance on either the PTx or PRx side. However, 15 W is just one example of such a threshold, and this threshold could be 10 W, 12 W, 16 W, 18 W, 20 W, 22 W, 25 W, 28 W, 30 W, 32 W, 35 W, 38 W, 40 W, 45 W, 50 W, or any other suitable value. If a degree of hysteresis is desired, an additional power threshold could be used to indicate the return to a low power regime. Such a threshold might be 9 W, although any value less than the high power threshold could be used, such as a value of 12 W, 10W, 7.5 W, 5 W, etc. Unless otherwise specified herein or in the appended claims any of the above-described values could be employed; however, for at least some applications, there may be advantageous reasons to employ certain specific thresholds.

Described above are various features and embodiments relating to system and operating parameter measurement in wireless power transfer systems. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices' ability to provide wireless power signals to each other in an efficient manner to facilitate battery charging, such as by sharing of the devices' power handling capabilities with one another. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

1. A wireless power transmitter comprising:
a wireless power transfer coil configured to magnetically couple to a corresponding coil of a wireless power receiver to perform wireless power transfer to the wireless power receiver;
an inverter that receives a DC input voltage and produces an AC output voltage that is provided to the wireless power transfer coil to perform the wireless power transfer; and
control and communication circuitry coupled to the wireless power transfer coil and the inverter, wherein the control and communication circuitry:
initiates a temporary pause of the wireless power transfer;
provides a ping signal to cause a resonant voltage in the wireless power transfer coil during the temporary pause of wireless power transfer;
uses the resonant voltage to measure or characterize one or more parameters characterizing a wireless power transfer link between the wireless power transmitter and the wireless power receiver; and
thereafter resumes wireless power transfer by ending the temporary pause of wireless power transfer, wherein resuming wireless power transfer includes a soft restart of the inverter.

2. The wireless power transmitter of claim 1 wherein the soft restart of the inverter is achieved by varying a switching duty cycle of the inverter.

3. The wireless power transmitter of claim 1 wherein the inverter is a full bridge inverter, and the soft restart of the inverter is achieved by varying a phase between switching operations of a first half bridge of the full bridge inverter and a second half bridge of the full bridge inverter.

4. The wireless power transmitter of claim 3 wherein the control and communication circuitry includes:
a resonant capacitor and one or more switching devices operable to selectively provide a resonant current circulation path between the wireless power transfer coil and the resonant capacitor during the temporary pause; and
measurement circuitry that measures a resonant voltage associated with the wireless power transfer coil and the resonant capacitor caused by the ping signal.

5. The wireless power transmitter of claim 4 wherein the resonant capacitor and one or more switching devices include the resonant capacitor and a switching device coupled in series between a junction of the wireless power transfer coil with a tuning capacitance arrangement and ground.

6. The wireless power transmitter of claim 4 wherein the resonant capacitor and one or more switching devices include the resonant capacitor and a first switching device coupled in series between a junction of a first terminal of the wireless power transfer coil with a tuning capacitance arrangement and ground and a second switching device coupled between a second terminal of the wireless power transfer coil and ground.

7. The wireless power transmitter of claim 3 wherein the control and communication circuitry uses the resonant voltage to measure or characterize one or more parameters characterizing a wireless power transfer link between the wireless power transmitter and the wireless power receiver by measuring or characterizing one or more electrical, magnetic, or electromagnetic parameters characterizing a wireless power transfer link between the wireless power transmitter and an external object.

8. The wireless power transmitter of claim 7 wherein the one or more electrical, magnetic, or electromagnetic parameters characterizing a wireless power transfer link are used to detect a wireless power receiver.

9. The wireless power transmitter of claim 7 wherein the one or more electrical, magnetic, or electromagnetic parameters characterizing a wireless power transfer link are used to detect a foreign object.

10. The wireless power transmitter of claim 4 wherein the resonant voltage associated with the wireless power transfer coil and the resonant capacitor is a ringing signal induced by the ping signal.

11. A wireless power transmitter comprising:
a wireless power transfer coil configured to magnetically couple to a corresponding coil of a wireless power receiver to perform wireless power transfer to the wireless power receiver;
an inverter that receives a DC input voltage and produces an AC output voltage that is provided to the wireless power transfer coil to perform the wireless power transfer; and
control and communication circuitry coupled to the wireless power transfer coil and the inverter, wherein the control and communication circuitry:
initiates a temporary pause of the wireless power transfer;
provides a ping signal to cause a resonant voltage in the wireless power transfer coil during the temporary pause of wireless power transfer;
uses the resonant voltage to measure or characterize one or more parameters characterizing a wireless power transfer link between the wireless power transmitter and the wireless power receiver; and
thereafter resumes wireless power transfer by ending the temporary pause of wireless power transfer;
wherein the control and communication circuitry includes a resonant capacitor and one or more switching devices operable to selectively provide a resonant current circulation path between the wireless power transfer coil and the resonant capacitor during the temporary pause and measurement circuitry that measures a resonant voltage associated with the wireless power transfer coil and the resonant capacitor caused by the ping signal.

12. The wireless power transmitter of claim 11 wherein:
the inverter is a full bridge inverter;
resuming wireless power transfer includes a soft restart of the inverter; and
the soft restart of the inverter is achieved by varying a phase between switching operations of a first half bridge of the full bridge inverter and a second half bridge of the full bridge inverter.

13. The wireless power transmitter of claim 11 wherein:
resuming wireless power transfer includes a soft restart of the inverter; and
the soft restart of the inverter is achieved by varying a switching duty cycle of the inverter.

14. The wireless power transmitter of claim 11 wherein the resonant capacitor and one or more switching devices include the resonant capacitor and a switching device coupled in series between a junction of the wireless power transfer coil with a tuning capacitance arrangement and ground.

15. The wireless power transmitter of claim 11 wherein the resonant capacitor and one or more switching devices include the resonant capacitor and a first switching device coupled in series between a junction of a first terminal of the wireless power transfer coil with a tuning capacitance arrangement and ground and a second switching device coupled between a second terminal of the wireless power transfer coil and ground.

16. The wireless power transmitter of claim 11 wherein the control and communication circuitry uses the resonant voltage to measure or characterize one or more parameters characterizing a wireless power transfer link between the wireless power transmitter and the wireless power receiver by measuring or characterizing one or more electrical, magnetic, or electromagnetic parameters characterizing a wireless power transfer link between the wireless power transmitter and an external object.

17. The wireless power transmitter of claim 16 wherein the one or more electrical, magnetic, or electromagnetic parameters characterizing a wireless power transfer link are used to detect a wireless power receiver.

18. The wireless power transmitter of claim 16 wherein the one or more electrical, magnetic, or electromagnetic parameters characterizing a wireless power transfer link are used to detect a foreign object.

19. The wireless power transmitter of claim 16 wherein the resonant voltage associated with the wireless power transfer coil and the resonant capacitor is a ringing signal induced by the ping signal.

20. A method of operating a wireless power transmitter including an inverter that drives a wireless power transfer coil to deliver power to a wireless power receiver, the method comprising using wireless power transmitter control circuitry to:
initiate a temporary pause of wireless power transfer;
provide a ping signal to cause a resonant voltage in the wireless power transfer coil during the temporary pause of wireless power transfer;
use the resonant voltage to measure or characterize one or more electrical, magnetic, or electromagnetic parameters characterizing a wireless power transfer link between the wireless power transmitter and the wireless power receiver; and
thereafter resume wireless power transfer by ending the temporary pause of wireless power transfer, wherein resuming wireless power transfer includes a soft restart of the inverter;
wherein providing the ping signal comprises operating circuitry including:
a resonant capacitor and one or more switching devices operable to selectively provide a resonant current circulation path between the wireless power transfer coil and the resonant capacitor during the temporary pause; and
measurement circuitry that measures a resonant voltage associated with the wireless power transfer coil and the resonant capacitor caused by the ping signal.

21. The method of claim 20 wherein:
the inverter is a full bridge inverter; and
the soft restart of the inverter includes varying a phase between switching operations of a first half bridge of the full bridge inverter and a second half bridge of the full bridge inverter.

22. The method of claim 20 wherein the soft restart of the inverter is achieved by varying a switching duty cycle of the inverter.

23. The method of claim 20 wherein the resonant capacitor and one or more switching devices include the resonant capacitor and a switching device coupled in series between a junction of the wireless power transfer coil with a tuning capacitance arrangement and ground.

24. The method of claim 20 wherein the resonant capacitor and one or more switching devices include the resonant capacitor and a first switching device coupled in series between a junction of a first terminal of the wireless power transfer coil with a tuning capacitance arrangement and ground and a second switching device coupled between a second terminal of the wireless power transfer coil and ground.

25. The method of claim 20 wherein the resonant voltage associated with the wireless power transfer coil and the resonant capacitor is a ringing signal induced by the ping signal.
